(19) United States
(12) Patent Application Publication
(10) Pub. No.: US 2025/0335160 A1
(43) Pub. Date: Oct. 30, 2025

(54) SYSTEMS AND METHODS FOR STRATEGIC APPLICATION MODERNIZATION ASSESSMENT

(71) Applicant: CDW LLC, Vernon Hills, IL (US)

(72) Inventor: Gregory L. Peters, Columbia, SC (US)

(21) Appl. No.: 18/644,952

(22) Filed: Apr. 24, 2024

(51) Int. Cl. G06F 8/35

(52) U.S. Cl. CPC G06F 8/35

(57) ABSTRACT

Systems and methods for application modernization using machine learning (ML) are disclosed herein. An example system receives software development information corresponding to one or more applications, the software development information including human-readable code. The system provides the software development information to an ML model. The ML model is trained using application modernization training data corresponding to best practices for modernizing historical applications based upon historical software development information. The ML model includes a large language model trained to interpret the human-readable code. The ML model generates application modernization information corresponding to at least one application of the one or more applications. The application modernization information includes technical requirements of a corresponding application, and application modernization recommendations of the corresponding application based upon the one or more technical requirements. In response to generating the application modernization information, the system provides the application modernization information to a computing device.

### FIELD OF THE DISCLOSURE

The present disclosure generally relates to application modernization, and in particular, systems and methods for application modernization using machine learning.

### BACKGROUND

The background description provided herein is for generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Modernizing a portfolio of software applications may be beneficial and necessary over time, for example to take advantage of technological advancements in software and hardware, to reduce the cost of supporting applications which are ripe for retirement due to underuse or providing similar functionality as other applications, and the like. The application modernization process generally involves manually evaluating each application to understand its characteristics, such as the purpose it serves for the end user, how it is coded, its technical features, resources required for execution, among other things.

However, gathering, analyzing, and understanding the information relevant to modernizing a single application, such as application source code, application metadata, and application commits, can be a time-consuming and error-prone process using conventional techniques. For instance, the application code may be difficult to read and understand due to the programming language, syntax, or other complexities, which may detrimentally affect comprehension of the technical requirements or relevant modernization information indicated therein. The application developer can provide insights pertinent to modernizing application's they developed, such as considerations which inform application development decisions, choices, and strategies (e.g., coding languages and techniques, supported platforms, application security requirements, application development roadmaps, etc.), suggestions of best practices for application modernization, among others.

However, when the application developer is unavailable, the loss of their insight and knowledge may further detrimentally affect the ability to thoroughly evaluate the application for modernization. For example, the application developer's absence (1) represents a loss of critical input/insight when answering questions related to application modernization, (2) delays application modernization, and (3) results in a reliance on outdated, unmodernized applications having inferior characteristics (e.g., a lack of stability, interoperability, security, speed of execution, required resources such as memory, etc.), as compared to a modernized application. Unavailability of the application developer also wastes time and resources developing a knowledgebase associated with the application that is already known to the application developer, such as time and effort to train or educate a different developer, etc.

These issues experienced by conventional techniques are further exacerbated when attempting to modernize multiple applications (e.g., tens or hundreds of applications). For example, the functionality of each application must be evaluated individually and in relation to every other application to determine distinct technical characteristics and/or which applications have the same or similar functionalities. If the functional and/or technical characteristics of the applications go undetected, are incorrectly interpreted, and/or are otherwise misunderstood, attempts at modernizing the applications are inadequate or less effective than they otherwise would be.

Accordingly, improved methods and systems for assessing and/or implementing application modernization in an automated fashion are needed, to reduce the time, cost, and human-error involved, as well as improve the quality of the service provided during the application modernization process.

### BRIEF SUMMARY

This Brief Summary is provided to introduce a selection of concepts that are further described below in the Detailed Description in a simplified form. This Brief Summary is not intended to identify key features or essential features of the claimed subject matter, nor is it intended to be used to limit the scope of the claimed subject matter.

In one aspect, a system for application modernization using machine learning (ML) is provided. The system includes one or more memories having stored thereon computer-executable instructions, and one or more processors. The instructions, when executed by the one or more processors, cause the computing system to: receive software development information corresponding to one or more applications, the software development information including human-readable code; provide the software development information to an ML model, wherein the ML model: (i) is trained using application modernization training data corresponding to best practices for modernizing historical applications based upon historical software development information, (ii) includes a large language model (LLM) trained to interpret the human-readable code, and (iii) generates application modernization information corresponding to at least one application of the one or more applications, the application modernization information including (a) one or more technical requirements of a corresponding application and (b) one or more application modernization recommendations of the corresponding application based upon the one or more technical requirements; and responsive to generating the application modernization information, provide the application modernization information to a computing device.

In a variation of this embodiment, the application modernization information includes a heatmap indicating one or more of application cloud readiness or application modernization complexity diagrams.

In another variation of this embodiment, the one or more technical requirements include at least one of: (i) application functionality, (ii) application rules, (iii) user experiences, (iv) application security, (v) application deployment, or (vi) application performance.

In yet another variation of this embodiment, the application modernization information indicates more than one application having a same technical requirement.

In still another variation of this embodiment, the one or more application modernization recommendations include at least one of: (i) deduplicating applications having redundant technical requirements, (ii) generating new source code for an application, (iii) rewriting existing source code of the application, (iv) retiring the application, (v) retaining the application, (vi) replatforming the application, (vii) repurchasing the application, or (viii) rehosting the application.

In yet another variation of this embodiment, the ML model is further trained to generate the new source code, and/or rewrite the existing source code, and the system further includes instructions that, when executed by the one or more processors, cause the system to: generate, via the ML model, at least a portion of the new source code; and/or rewrite, via the ML model, at least a portion of the existing source code.

In still another variation of this embodiment, the ML model includes an ML chatbot, and to generate the application modernization information, the system further includes instructions that, when executed by the one or more processors, cause the system to: receive, from the computing device, a request associated with modernizing an application of the one or more applications; provide the request to the ML chatbot, wherein the ML chatbot is trained at least to generate responses that emulate technical knowledge of an application developer of the application; generate, by the ML chatbot, a response to the request; and provide the response to the computing device.

In yet another variation of this embodiment, the instructions, when executed by the one or more processors, cause the system to: train a base ML model using generic application developer training data corresponding to best practices of a generic application developer; fine-tune the base ML model using one or more specific application developer training datasets corresponding to one or more specific application developers of the one or more applications, each specific application developer training dataset representing technical knowledge of a specific application developer for a corresponding application, and to generate one or more fine-tuned ML models associated with the one or more specific application developers; and store the one or more fine-tuned ML models on the one or more memories, wherein the ML chatbot is one such fine-tuned ML model.

In still another variation of this embodiment, each specific application developer training dataset indicates source code changes of the specific application developer for the corresponding application.

In yet another variation of this embodiment, the instructions, when executed by the one or more processors, cause the system to: obtain an indication of a specific application developer, of the one or more specific application developers; identify the fine-tuned ML model associated with the indicated specific application developer; and retrieve the identified fine-tuned ML model from the one or more memories, for use as the ML chatbot.

In still another variation of this embodiment, the indication is based upon the application developer of the application indicated by the request.

In another embodiment, a system for application modernization using an ML chatbot is provided. The system includes one or more memories having stored thereon computer-executable instructions, and one or more processors. The instructions, when executed by the one or more processors, cause the computing system to: receive, from a user via a computing device, a request associated with modernizing an application; provide the request to the ML chatbot, wherein the ML chatbot is trained at least to generate responses that emulate technical knowledge of an application developer of the application; in response to providing the request to the ML chatbot, generate, by the ML chatbot, a response to the request; and provide the response to the computing device.

In yet another embodiment, a computer-implemented method for application modernization using ML is provided. The computer-implemented method includes: receiving, by one or more processors, software development information corresponding to one or more applications, the software development information including human-readable code; providing, by the one or more processors, the software development information to an ML model, wherein the ML model: (i) is trained using application modernization training data corresponding to best practices for modernizing historical applications based upon historical software development information, (ii) includes a large language model LLM trained to interpret the human-readable code, and (iii) generates application modernization information corresponding to at least one application of the one or more applications, the application modernization information including (a) one or more technical requirements of a corresponding application and (b) one or more application modernization recommendations of the corresponding application based upon the one or more technical requirements; and providing, by the one or more processors, the application modernization information to a computing device.

In a variation of this embodiment, the one or more technical requirements include at least one of: (i) application functionality, (ii) application rules, (iii) user experiences, (iv) application security, (v) application deployment, or (vi) application performance.

In another variation of this embodiment, the one or more application modernization recommendations include at least one of: (i) deduplicating applications having redundant technical requirements, (ii) generating new source code for an application, (iii) rewriting existing source code of the application, (iv) retiring the application, (v) retaining the application, (vi) replatforming the application, (vii) repurchasing the application, or (viii) rehosting the application.

In yet another variation of this embodiment, the ML model is further trained to generate the new source code, and/or rewrite the existing source code; and the computer-implemented method further includes: generating, via the ML model, at least a portion of the new source code; and/or rewriting, via the ML model, at least a portion of the existing source code.

In still another variation of this embodiment, the ML model includes an ML chatbot; and generating the application modernization information further includes: receiving, by the one or more processors from the computing device, a request associated with modernizing an application of the one or more applications; providing, by the one or more processors, the request to the ML chatbot, wherein the ML chatbot is trained at least to generate responses that emulate technical knowledge of an application developer of the application; generating, by the ML chatbot, a response to the request; and providing, by the one or more processors, the response to the computing device.

In yet another variation of this embodiment, the computer-implemented further includes: training, by the one or more processors, a base ML model using generic application developer training data corresponding to best practices of a generic application developer; fine-tuning, by the one or more processors, the base ML model using one or more specific application developer training datasets corresponding to one or more specific application developers of the one or more applications, each specific application developer training dataset representing technical knowledge of a specific application developer for a corresponding application, and to generate one or more fine-tuned ML models associated with the one or more specific application developers; and storing, by the one or more processors, the one or more fine-tuned ML models on one or more memories, wherein the ML chatbot is one such fine-tuned ML model.

In still another variation of this embodiment, the computer-implemented method further includes: obtaining, by the one or more processors, an indication of a specific application developer, of the one or more specific application developers; identifying, by the one or more processors, the fine-tuned ML model associated with the indicated specific application developer; and retrieving, by the one or more processors, the identified fine-tuned ML model from the one or more memories, for use as the ML chatbot.

In still yet another variation of this embodiment, the indication is based upon the application developer of the application indicated by the request.

### BRIEF DESCRIPTION OF THE DRAWINGS

FIG. 1 depicts an example computing environment 100 for application modernization using ML, in accordance with various embodiments herein;

FIG. 2 depicts a data flow diagram for example training and operation of an ML model for application modernization, in accordance with various embodiments herein;

FIG. 3A depicts a block diagram of example application modernization system using ML, in accordance with various embodiments herein;

FIG. 3B depicts an example computing device user interface displaying application modernization information;

FIG. 3C depicts a block diagram of an example ML chatbot system for application modernization, in accordance with various embodiments herein;

FIG. 4 depicts a flow chart of an example computer-implemented method for application modernization using ML, in accordance with various embodiments herein.

### DETAILED DESCRIPTION

### Overview

The present techniques include a description of systems and methods for providing application modernization using machine learning (ML). In one embodiment, a system receives software development information corresponding to one or more applications. The software development information may include information associated with developing the corresponding software applications, such as source-code, metadata, developer comments, application commits/change information, application knowledgebase information, etc. In one aspect, the software development information includes human-readable code. As used herein, “human-readable code” refers to application code which a person skilled in the art can read to understand the functionality of the application, for example reading and understanding the syntax and functionality of application source code written in an alphanumeric-based programming language such as C+ or Java. Human-readable code may be differentiated from other application codes like binary code or machine code which, although written in alphanumeric characters such as zeros and ones which are recognizable by a human, has associated functionality that the human reader likely cannot understand by reading the code alone.

The system may provide the software development information to an ML model that is trained to generate application modernization information corresponding to at least one application. The application modernization information may include technical requirements of a corresponding application and one or more application modernization recommendations, or any other suitable information pertinent to application modernization. The system may provide the application modernization information to a computing device.

The ML model may include a large language model (LLM) trained to interpret the human-readable code and/or software development information, for example to understand the technical requirements indicated by the human-readable code or software development information. The technical requirements may include (i) functionality of the application (e.g., application features and capabilities), (ii) rules of the application (e.g., business rules, logic, guidelines and/or conditions governing the application behavior), (iii) user experiences, (iv) application security (e.g., encryption, user access restrictions), (v) application deployment (e.g., deploying the application from development and/or testing environments), (vi) application performance (e.g., resource utilization, load/execution time), and/or any other suitable technical requirement of an application.

The application modernization recommendations may generally include one or more recommendations to (i) deduplicate applications having redundant technical requirements, (ii) generate new source code for the application, (iii) rewrite existing source code of the application, (iv) retire the application, (v) retain the application, (vi) replatform the application, (vii) repurchase the application, (viii) rehosting the application (e.g., in the cloud), and/or any other suitable application modernization recommendation. In one aspect, the ML model is further trained to generate the new source code, and/or rewrite the existing source code, such as code indicated by the application modernization recommendations.

Advantageously, the technical requirements and application modernization recommendations improve the overall operation of the application system which provides the applications, as well as the modernized application themselves. In one example, application modernization includes identifying multiple applications having redundant technical requirements, such as redundant functionality, application rules, etc., and providing application modernization recommendations to retire the applications having redundant technical requirements of another application, so the redundant applications are no longer available for use. Retiring applications from the application system improves the application system, as the application system no longer requires resources to execute and/or store (e.g., available memory, processor cycles) the retired applications, which benefits operation of the application system, e.g., when using the additional resources made available by application modernization to operate other applications.

As another example, the technical requirements indicate performance characteristics of an application and the corresponding application modernization recommendation indicates that rehosting the application using a cloud server with faster operations and data throughput than the current local hosting server will improve the performance characteristics of the application. Consequently, rehosting the application on the cloud server based on the application modernization recommendation generated by the ML model of the present disclosure directly improves the speed and overall responsiveness of the application.

In yet another example, the application modernization recommendation indicates generating or rewriting code of the application to improve its security characteristics and/or security requirements, as indicated by the corresponding technical requirements. In certain embodiments, the ML model and/or other systems of the present disclosure may then recode the application in accordance with the application modernization recommendation to resolve exploits in the original code which allow a bad actor to steal user credentials, inject malware into the application system, etc. Recoding the application in accordance with the application modernization recommendation thereby prevents malware corruption of the applications, which improves the overall security of the application and host application system. Moreover, application modernization indicated by the aforementioned examples, and as described herein, also improves the end-user experience when interacting with modernized applications with improved security, performance, and/or other characteristics.

In one aspect, the application modernization information includes one or more heatmaps, for example heatmaps indicating application cloud readiness or application modernization complexity diagrams. In one aspect, the application modernization information indicates multiple applications having technical requirements which are the same, which may be useful information, for example, when determining whether to modernize an application portfolio by eliminating redundant technical requirements across the portfolio's applications.

In some embodiments, the system for application modernization includes an ML chatbot. In such embodiments, the system may be configured to receive, from a computing device, a request associated with modernizing the application. The system may provide the request to the ML chatbot which is trained to generate responses that emulate the technical knowledge of an application developer of the application. Accordingly, in response to receiving the request, the ML chatbot may generate a response to the request which emulates the developer's technical knowledge, and the system may provide the response to the computing device. The developer's technical knowledge may allow the ML chatbot to provide information and responses associated with application modernization which the developer would likely make. For example, the ML chatbot may provide responses indicating how the developer would modernize applications.

Such insights are unavailable using conventional techniques, for example in scenarios where developers become unavailable (e.g., leave employment) without passing their knowledge along to others who remain available, etc. As mentioned, these conventional techniques correspondingly suffer from delays in application modernization, a reliance on outdated, unmodernized applications having inferior performance characteristics, and wasted time and resources re-constructing the developer's knowledgebase (e.g., training/educating a different developer). Consequently, the present systems reduce and/or eliminate these issues by leveraging stored developer knowledge for future use in application modernization, particularly in the absence of the developer.

In one example, to modernize an application developed by an original application developer associated with the ML chatbot, a new application developer can interact with the ML chatbot to pose a question associated with the application. Using conventional techniques, the new application developer would expend significant time and effort to gather, analyze, and comprehend various types of application information, such as source code, commits, and change logs of files associated with the application. To further complicate matters, this application information is often stored in disparate repositories, leading to tediously long search times to recover the information. Once gathered, the new application developer must then read the application information in an attempt to understand the source code, as well as glean the underlying and likely unstated rationale of the original application developer (e.g., coding language and syntax choices), and finally attempt to intuit what the original application developer may have suggested for application modernization based on their technical knowledge and considerations associated with the application, the end-user, and/or the application provider. By contrast, using the present techniques, the new application developer inputs questions to the ML chatbot which automatically considers and incorporates the original application developer's knowledge to generate information/responses that expeditiously and accurately answer the new application developer's questions.

In one aspect, the system trains a base ML model using generic application developer training data corresponding to best practices of a generic application developer. The system may fine-tune the base ML model using specific application developer training datasets corresponding to specific application developers of the applications, each specific application developer training dataset representing the technical knowledge of a specific application developer for a corresponding application. The system may generate one or more fine-tuned ML models associated with one or more specific application developers, and use one of the fine-tuned ML models as the ML chatbot. In one aspect, to determine which fine-tuned model to use as the ML chatbot, the system may obtain an indication of one of the specific application developers. In one example, the indication is based upon the application of the ML chatbot request. For example, the developer of the application, which is the subject of the request, is automatically indicated by virtue of the request. The system may identify the fine-tuned ML model associated with the indicated specific application developer, and retrieve the identified fine-tuned ML model from memory, for use as the ML chatbot.

The aforementioned benefits the ML chatbot provides when trained with technical knowledge of a single application developer respective to a single application, are multiplied when modernizing several applications that are developed by several application developers. For example, applications that are developed by multiple developers, and made available for use across the span of many years are no longer detrimentally impacted by the unavailability of the application developers when modernizing the application, which may take place many times over the years. Rather than lose the developer's knowledge should the application developers leave the organization and/or otherwise become unavailable, and/or their technical knowledge associated with developing the applications fades from memory even if they remain available, the application modernization process still benefits from the technical knowledge of the many application developers via the techniques of the present disclosure. Training ML chatbots to have the technical knowledge of multiple application developers, and having the ML chatbots available to provide developer technical knowledge for application modernization purposes, improves the technical field of application modernization. Such improvements may include providing application modernization at multiple times to improve performance and security of the applications, reduce resources to store and execute the applications, and eliminate retraining and reeducation of new developers, all without requiring the developer to be present. The following disclosure includes numerous examples of functionality facilitated by the present techniques.

In accordance with the above, and with the disclosure herein, the present disclosure includes improvements in computer functionality or improvements to other technologies, at least because the present disclosure describes that, e.g., application modernization processes and their related various components, may be improved or enhanced. The disclosed systems and methods provide techniques to assess and/or implement application modernization in an automated fashion. The techniques implement the ML model, including the LLM, trained to understand the software development information and/or human-readable code provided as an input. In response, the ML model generates as an output application modernization information that includes technical requirements.

The technical requirements indicate characteristics of the application that may be misunderstood or completely missed using the existing techniques, such as when manually reviewing and interpreting unfamiliar application code in an attempt to determine the technical requirements that may be indicated therein. Thus, training the ML model to understand human-readable code, extract the technical requirements from the software development information, and generate application modernization recommendations based upon the technical requirements results in improved techniques for application modernization. The improved techniques can result in reducing the time, cost, and human-error that may be involved in extracting the technical requirements during manual review of such information, and/or when using less-sophisticated technologies and methodologies, as well as generating the application modernization recommendations based upon the technical requirements.

That is, the present disclosure describes improvements in the functioning of a system for application modernization itself, or “any other technology or technical field” (e.g., the field of application modernization technologies and services) because the disclosed systems and methods improve and enhance application modernization by implementing ML model(s) configured to interpret human-readable code and software development information, which is lacking in previous application modernization systems. This improves the state of the art at least because such previous application modernization systems are inefficient and error-prone, as they lack the ability to understand software development information and human-readable code in the manners described in the present disclosure, such as by generating technical requirements indicated in the software development information and/or generating application modernization recommendations based upon the technical requirements.

The present disclosure describes improvements in the functioning of a system for application modernization itself, or any other technology or technical field such as application modernization technologies and services, because the disclosed systems and methods improve and enhance application modernization by incorporating developer knowledge into a ML chatbot to generate responses and information associated with application modernization. Incorporating the developer knowledge into a ML chatbot eliminates the need to have the developer of a software application available to answer questions relating to the corresponding application and/or application modernization thereof, while preserving the developer-specific knowledge and insights relevant to application modernization which the disclosed systems use to generate responses.

Incorporating knowledge of developer best practices provides yet another layer of technological improvement to the technical field of application modernization and system providing application modernization. Conventional techniques for application modernization frequently recommend application modernization actions/strategies that ignore and/or run-afoul of such best practices. For example, conventional techniques may include a recommendation to modernize an application by recoding it in a coding language which is more memory and resource intensive than another coding language and is therefore contrary to developer best practices. The techniques of the present disclosure reduce and/or eliminate these issues suffered by conventional techniques by training a ML model/chatbot with knowledge of best practices to modernize applications, such that the best practices may directly influence responses output by the ML model/chatbot.

In addition, the present disclosure includes applying various features and functionality, as described herein, with, or by use of, a particular machine, e.g., a machine to operate the LLM, the ML model, the fined-tuned ML chatbot emulating developer knowledge, and/or other hardware components as described herein.

Moreover, the present disclosure includes specific features other than what is well-understood, routine, conventional activity in the field, or adding unconventional steps that demonstrate, in various embodiments, particular useful applications. For example, providing the software development information to an ML model trained with best practices for modernizing applications, including the LLM to interpret the human-readable code, generating application modernization information including technical requirements of applications, providing responses to user requests via the ML chatbot trained to the emulate technical knowledge of an application's developer.

### Example Computing Environment

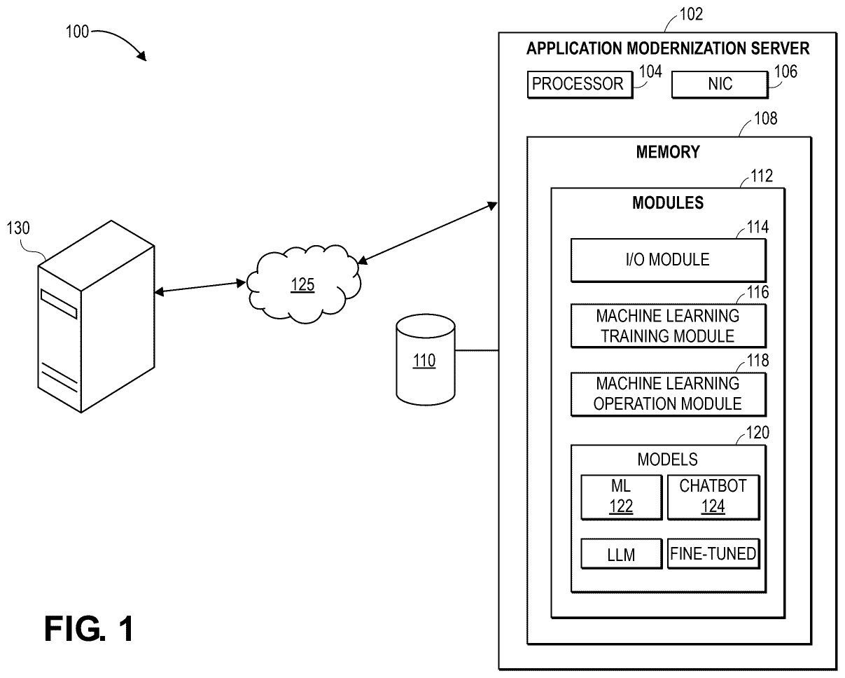

FIG. 1 depicts an example computing environment 100 for application modernization using ML, according to some aspects. The computing environment 100 may include an application modernization server 102, a network 125, and a computing device 130.

The application modernization server 102 may include a processor 104, a network interface controller (NIC) 106, a memory 108, and a database 110. The application modernization server 102 may be part of a cloud network or may otherwise communicate with other hardware or software components within one or more cloud computing environments to send, retrieve, or otherwise analyze data or information described herein. In one example, in certain aspects of the present techniques, the computing environment 100 may comprise an on-premise computing environment, a multi-cloud computing environment, a public cloud computing environment, a private cloud computing environment, and/or a hybrid cloud computing environment. In one example, the server 102 may be and/or include a virtual machine. In one example, the server 102 may be a computing device which is isolated (“air-gapped) from the network 125 for at least a period of time, e.g., air-gapping the server 102 while generating the application modernization information for security purposes. In one example, an entity (e.g., a business offering application modernization) may host one or more services in a public cloud computing environment, e.g., Amazon Web Services (AWS), Google Cloud, IBM Cloud, Microsoft Azure, etc. The public cloud computing environment may be a traditional off-premise cloud (i.e., not physically hosted at a location owned/controlled by the business). Alternatively, or in addition, aspects of the public cloud may be hosted on-premise at a location owned/controlled by the business. The public cloud may be partitioned using visualization and multi-tenancy techniques and/or may include one or more of software-as-a-service (SaaS), infrastructure-as-a-service (laaS) and/or platform-as-a-service (PaaS).

The network 125 may be a single communication network, or may include multiple communication networks of one or more types (e.g., one or more wired and/or wireless local area networks (LANs), and/or one or more wired and/or wireless wide area networks (WANs) such as the Internet). The network 125 may enable bidirectional communication between the application modernization server 102, the computing device 130, and/or other devices and components of the computing environment 100. In one aspect, the network 125 may comprise a cellular base station, such as cell tower(s), communicating to the one or more components of the computing environment 100 via wired/wireless communications based upon any one or more of various mobile phone standards, including NMT, GSM, CDMA, UMTS, LTE, 5G, 6G, or the like. Additionally, or alternatively, the network 125 may comprise one or more routers, wireless switches, or other such wireless connection points communicating to the components of the computing environment 100 via wireless communications based upon any one or more of various wireless standards, including by non-limiting example, IEEE 802.11a/ac/ax/b/c/g/n (Wi-Fi), Bluetooth, and/or the like.

The application modernization server 102 may include a processor 104. The processor 104 may include one or more processors, such as one or more central processing units (CPUs), graphics processing units (GPUs), and/or any other suitable processor. The processor 104 may be communicatively coupled to the memory 108 via a computer bus (not depicted) to create, read, update, transmit, delete, or otherwise access or interact with the data, data packets, or otherwise electronic signals to and from the processor 104 and the memory 108, e.g., in order to implement or perform the machine-readable instructions, methods, processes, elements, or limitations, as illustrated, depicted, or described for the various flowcharts, illustrations, diagrams, figures, and/or other disclosure herein. The processor 104 may interface with the memory 108 via a computer bus to execute an operating system and/or computing instructions contained therein, and/or to access other services/aspects. For example, the processor 104 may interface with the memory 108 via the computer bus to create, read, update, delete, or otherwise access or interact with the data stored in the memory 108 and/or the database 110.

The application modernization server 102 may include the NIC 106 which allows the application modernization server 102 to communicate over the network 125 (e.g., with the computing device 130, the database 110) via any suitable wired and/or wireless connection, and/or interface of the NIC 106. The NIC 106 may include one or more transceivers (e.g., WWAN, WLAN, and/or WPAN transceivers) functioning in accordance with IEEE reference standards, 3GPP reference standards, and/or other reference standards that may be used in receipt and transmission of data via external/network ports of the application modernization server 102 connected to the network 125.

The application modernization server 102 may include the memory 108. The memory 108 may include one or more memories and/or forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others. The memory 108 may store machine-readable instructions executable by the processor 104.

The memory 108 may store applications, such as the operating system (e.g., Microsoft Windows, Linux, UNIX, etc.) capable of facilitating the functionalities, applications, methods, or other software as discussed herein. In general, a computer program or computer based product, application, instructions, or code (e.g., machine learning models, or other computing instructions described herein) may be stored on a computer usable storage medium, or tangible, non-transitory computer-readable medium (e.g., standard random access memory (RAM), an optical disc, a universal serial bus (USB) drive, or the like) having such computer-readable program code or computer instructions embodied therein, wherein the computer-readable program code or computer instructions may be installed on or otherwise adapted to be executed by the processor(s) 104 (e.g., working in connection with the respective operating system in the memory 108) to facilitate, implement, or perform the machine readable instructions, methods, processes, elements or limitations, as illustrated, depicted, or described for the various flowcharts, illustrations, diagrams, figures, and/or other disclosure herein. In this regard, the program code may be implemented in any desired program language, and may be implemented as machine code, assembly code, byte code, interpretable source code or the like (e.g., via Golang, Python, C, C++, C#, Objective-C, Java, Scala, ActionScript, JavaScript, HTML, CSS, XML, etc.).

The application modernization server 102 may include, and/or have access to (e.g., via the network 125), the database 110. The database 110 may include one or more databases. The database 110 may be or include a relational database, such as Oracle, DB2, MySQL, a NoSQL based database, such as MongoDB, or another suitable database. The database 110 may store data and/or datasets discussed herein, such as software development information, application modernization information, training data/datasets (e.g., to train and/or operate one or more ML models), one or more ML models (e.g., trained models, fine-tuned models, chatbots), ML model input data, ML model output data, etc. The dataset may include one or more types of data, records, files, etc. The terms “data” and “dataset” may be used interchangeably herein.

The application modernization server 102 may include modules 112. Each of the modules 112 implements specific functionality related to the present techniques, as will be described further, below. In aspects wherein the application modernization server 102 is implemented using multiple servers, different servers may include different modules 112. For example, a first server may include the ML training module 116 to train one or more ML models, while another server may include ML operation module 118 to operate one or more ML models trained by the first server ML training module 116. The modules 112 may exchange data among the plurality of computing devices via a network such as the network 125. The modules 112 of FIG. 1 will now be described in greater detail.

Generally, the I/O module 114 includes instructions that enable a user of the application modernization server 102 to access and operate the application modernization server 102 (e.g., directly via user interface of the application modernization server 102, via the computing device 130 communicatively connected to the application modernization server 102 over network 125, etc.). For example, the application modernization server 102 may be used to train one or more ML models using the ML training module 116 in preparation for using the one or more trained ML models to generate outputs used for application modernization (e.g., application modernization information, chatbot responses to application modernizations requests, etc.). Once the one or more ML models are trained, the user may access the application modernization server 102 via the I/O module 114 to use the one or more trained models, or otherwise provide application modernization as described herein. The I/O module 114 may include instructions for generating one or more graphical user interfaces (GUIs) to provide application modernization services, such as GUls to receive/display user requests, provide/display responses to the requests, provide/display application modernization information (e.g., heatmaps, application technical requirements), etc. The I/O module 114 may include a communication component configured to communicate (e.g., send and receive) data via one or more external/network port(s) to one or more networks (e.g., the network 125) or components/devices, such as the computing device 130.

In one aspect, the modules 112 may include an ML training module 116 and/or an ML operation module 118. In some embodiments, at least one of a plurality of ML methods and algorithms may be applied by the ML training module 116 and/or the ML operation module 118, which may include, but are not limited to: linear or logistic regression, instance-based algorithms, regularization algorithms, decision trees, Bayesian networks, cluster analysis, association rule learning, artificial neural networks, deep learning, combined learning, reinforced learning, dimensionality reduction, and support vector machines. In various embodiments, the implemented ML methods and algorithms are directed toward at least one of a plurality of categorizations of ML, such as supervised learning, unsupervised learning, and reinforcement learning. In one aspect, the ML based algorithms may be included as a library or package executed on application modernization server 102. For example, libraries may include the TensorFlow based library, the PyTorch library, and/or the scikit-learn Python library. In one embodiment, the ML training module 116 may employ supervised learning, which involves identifying patterns in existing data to make predictions about subsequently received data. Specifically, the ML training module 116 trains using training data, which includes exemplary inputs and associated exemplary outputs. Based upon the training data, the ML training module 116 may generate a predictive function which maps outputs to inputs and may utilize the predictive function to generate ML outputs based upon data inputs. The exemplary inputs and exemplary outputs of the training data may include any of the data inputs or outputs described with respect to the ML models. In the exemplary embodiments, a processing element may be trained by providing it with a large sample of data with known characteristics or features.

In another embodiment, the ML training module 116 may employ unsupervised learning, which involves finding meaningful relationships in unorganized data. Unlike supervised learning, unsupervised learning does not involve user-initiated training based upon exemplary inputs with associated outputs. Rather, in unsupervised learning, the ML training module 116 may organize unlabeled data according to a relationship determined by at least one ML method/algorithm employed by the ML training module 116. Unorganized data may include any combination of data inputs and/or outputs as described herein with respect to the ML models.

In yet another embodiment, the ML training module 116 may employ reinforcement learning, which involves optimizing outputs based upon feedback from a reward signal. Specifically, the ML training module 116 may receive a user-defined reward signal definition, receive a data input, utilize a decision-making model to generate the ML output based upon the data input, receive a reward signal based upon the reward signal definition and the ML output, and alter the decision-making model so as to receive a stronger reward signal for subsequently generated ML outputs. Other types of ML may also be employed, including deep or combined learning techniques.

The ML training module 116 may receive labeled data at an input layer of a model having a networked layer architecture (e.g., an artificial neural network, a convolutional neural network, etc.) for training the ML model. The received data may be propagated through one or more connected deep layers of the ML model to establish weights of one or more nodes, or neurons, of the respective layers. Initially, the weights may be initialized to random values, and one or more suitable activation functions may be chosen for the training process. The present techniques may include training a respective output layer of the ML model. The output layer may be trained to output a prediction, for example.

The ML operation module 118 may comprise a set of computer-executable instructions implementing ML loading, configuration, initialization and/or operation functionality. The ML operation module 118 may include instructions for storing trained models (e.g., in the databases 110). As discussed, once trained, the trained ML model may be operated in inference mode, whereupon when provided with de novo input that the ML model has not previously been provided, the ML model may output one or more predictions, classifications, etc., as described herein.

In operation, ML model training module 116 may access the database 110, or any other data source for training data suitable to generate the ML model. The training data may be sample data with assigned relevant and comprehensive labels (classes or tags) used to fit the parameters (weights) of the ML model with the goal of training it by example. In one aspect, once an appropriate ML model is trained and validated to provide accurate predictions and/or responses, the trained model may be loaded into ML operation module 118 at runtime to process input data and generate output data.

While various embodiments, examples, and/or aspects disclosed herein may include training and generating one or more ML models for the server 102 to load at runtime, additionally or alternatively, one or more trained ML models may already exist (e.g., in the database 110) such that the application modernization server 102 may load an existing trained ML model at runtime. In some implementations, the application modernization server 102 may retrain, fine-tune, update and/or otherwise alter an existing ML model, such as before and/or after loading the ML model at runtime.

In one aspect, the modules 112 may include one or more models 120. Although the models 120 are illustrated as residing in the memory 108, in other embodiments, one or more of the models 120 may be stored in the database 110, and/or in any other suitable memory communicatively coupled to the application modernization server 102. The models 120 may include ML models, such as the ML model 122 trained using application modernization training data to generate the application modernization information. In one aspect, the application modernization training data includes data indicating and/or corresponding to best practices for modernizing applications based upon software development information. The ML model 122, and/or the models 120 more generally, may include the LLM trained to interpret and/or understand the human-readable code.

The models 120 may include an ML chatbot 124 configured to simulate human conversation, interact with users, understand their needs, and recommend an appropriate line of action with minimal and/or no human intervention, among other things. This may include providing the best response of any query that it receives and/or asking follow-up questions. In some aspects, the ML chatbot 124 may be and/or include the LLM. The LLM may be a publicly available LLM, such as OpenAI GPT-4, Meta LLaMa, or Google PaML 2, which is trained and/or fine-tuned to understand human-readable code, or software development information more generally. The ML chatbot 124 may employ supervised or unsupervised ML techniques, which may be followed by, and/or used in conjunction with, reinforced or reinforcement learning techniques.

The computing environment may include the computing device 130. The computing device 130 may be, and/or include, a server, a mobile computing device, a smart phone, a tablet, a laptop, a wearable device, or other suitable computing device. The computing device 130 may include an individual server, a group (e.g., cluster) of multiple servers, or another suitable type of computing device or system (e.g., a collection of computing resources). In some aspects, one or more components of the computing device 130 may be embodied by one or more virtual instances (e.g., a cloud-based virtualization service). The computing device 130 may be included in a respective remote data center (e.g., a cloud computing environment, a public cloud, a private cloud, hybrid cloud, etc.).

The computing device 130 may include a processor and NIC, such as the processor 104 and the NIC 106. The computing device 130 may include respective input device(s) and a respective output device(s). The respective input devices may include any suitable device or devices for receiving input, such as one or more microphone, one or more camera, a hardware keyboard, a hardware mouse, a capacitive touch screen, etc. The respective output devices may include any suitable device for conveying output, such as a hardware speaker, a computer monitor, a touch screen, etc. In some cases, the input device and the output device may be integrated into a single device, such as a touch screen device that accepts user input and displays output. The computing device 130 may be associated with one or more applications of a business, organization, or other entity, e.g., applications which may be modernized by the application modernization server 102. For example, the computing device 130 may be one of several servers owned/leased by a business for hosting various applications of an application portfolio.

In operation, the computing environment 100 may provide application modernization using ML. For example, an organization would like to determine whether any of the applications it provides to its end-users may be modernized. Modernizing an application may include retiring the application (e.g., when the application is no longer used and/or has duplicative functionality with another application), generating new source code and/or rewriting existing source code for the application (e.g., to improve the performance of the application, or add new functionality), replatforming the application (e.g. moving the application from one computing platform to another computing platform), repurchasing the application (e.g., repurchasing a newer version of a licensed application or another licensed application entirely), rehosting the application (e.g., moving an application which is hosted locally to the cloud), and/or any other suitable manner of modernizing the application. A business or other entity providing application modernization services may assess the applications for modernization, which may include determining which applications can be modernized, and/or modernizing the applications.

In one embodiment, the application modernization server 102 receives software development information corresponding to one or more applications. The software development information may include human-readable code, developer comments, metadata, commit information, etc. The application modernization server 102 may receive and or obtain (e.g., via the network 125) the software development information from any suitable source, such as from one or more computing devices 130 hosting the applications, application repositories and knowledgebases, a portable storage device (e.g., receiving the software development information on a portable USB hard drive when the application modernization server 102 is air-gapped), etc. In one aspect, the application modernization server 102 stores the software development information in a memory (e.g., the memory 108 and/or the database 110), for example to use as training data.

The application modernization server 102 may use the ML operation module 118 to load the ML model 122 (e.g., from the memory 108 stored as the models 120) trained to generate application modernization information. The ML model 122 may receive the software development information of one or more applications to generate the application modernization information corresponding to the one or more applications. In one example, the software development information indicates the coding language to write the source code of the application, and the metadata indicates the release date of each version of the application. The ML model 122 may use such information indicated in the software development information to determine that a new coding language having more efficient resource utilization was not yet available when the last version of the application was released, and therefore recoding the application using the new coding language may be indicated as one way to modernize the application.

As another example, developer comments associated with a first application may indicate that the first application is making a data call for information to a second application that is being recoded in six months. The comments may further indicate that the data call should be reevaluated in six months to ensure application interoperability, yet the corresponding first application commit information may indicate that the first application has not been updated in over eight months. The ML model 122 may use such information indicated in the software development information to determine that the first application data call needs to be recoded to modernize the application, and provide the determination to a computing device. In certain embodiments, the ML model 122 recodes some/all of the application.

In one aspect, the ML model 122 extracts technical requirements from, and indicated in, the software development information. For example, the ML model 122 may be trained to interpret the human-readable code or other textual information (e.g., developer comments, commit information, etc.) of the software development information to understand the technical requirements of each of the corresponding applications. The technical requirements may include application functionality, application rules, user experiences, application security, application deployment, application performance, and/or other suitable technical requirements of the application. In one aspect, the ML model 122 includes the LLM which is trained to interpret and/or understand the human-readable code or other textual information. The ML model 122 may be further trained to generate one or more application modernization recommendations for the application, based upon the corresponding technical requirements.

The application modernization information may include an identification of the applications that can be modernized, which may include a listing of applications for modernization, one or more heatmaps (e.g., indicating application cloud readiness, the complexity of application modernization), an indication of why the applications should be modernized (e.g., duplicative technical requirements across multiple applications, non-use of applications), an indication of how the applications can be modernized (e.g., rehosting, retiring), and/or other suitable information or application modernization recommendations associated with application modernization. For example, a portfolio of applications is being assessed for modernization. The application modernization information may include a heatmap that visually indicates application modernization recommendations for the applications using color coding, where the varying shades of the color coding help identify the “better” or “worse” outcomes of the application modernization. In one example, a cloud readiness heatmap may indicate the cloud readiness of applications in the portfolio, where darker shades of the heatmap indicate more beneficial potential outcomes from moving the application to the cloud than lighter shades. In one example, a complexity heatmap may visually indicate the level complexity associated with moving the portfolio of applications to the cloud, where darker shades indicate higher levels of complexity than lighter shades.

In response to generating the application modernization information, the application modernization server 102 may provide the application modernization information to one or more computing devices 130. For example, the server 102 may transmit the application modernization information via the network 125 to a computing device 130 associated with the provider of the application modernization services, a computing device 130 associated with the entity requesting application modernization, a computing device 130 communicatively coupled to the database 110 to the application modernization information therein, and/or any other suitable computing device 130.

In one embodiment, the ML model 122 is further trained to modernize one or more applications. The ML model 122 may be trained/configured with generative capabilities (e.g., using the LLM) to modernize an application, such as generating and/or rewrite code in one or more coding languages. This may include the coding language in which the application was originally written, a different coding language providing improvements to the application (e.g., reduced memory usage, faster execution, etc.), a different coding language to update existing code which is written in an obsolete coding language, etc. For example, an application is written in the Common Business Oriented Language (COBOL) coding language which is outdated and thus hard to support, and the application modernization includes rewriting the application in the C++ coding language via the ML model's generative capabilities.

In one embodiment, the application modernization server 102 may be configured provide the ML chatbot 124 trained to generate responses that emulate technical knowledge of a developer of an application. In such an embodiment, the application modernization server 102 may receive a request, e.g., from the computing device 130, and generate one or more responses in return. In one example, an application modernization website and/or application may be associated with the application modernization server 102, and provide an ML chatbot interface accessible via the computing device 130 for receiving requests. The requests may be associated with a particular application which may be modernized, and the application modernization server 102 may obtain an identification of a specific application developer associated with the application. This may include identifying the application developer that develops the original application code, and/or updates the application code. In one aspect, multiple application developers may be involved in developing the application The application modernization server 102 may select and/or identify the application developer based upon criteria, such as the application developer who generates a majority of the application code, who develops the code associated with the request, the developer best suited to respond to the request, etc.

In one aspect, the application modernization server 102 may be configured to identify the specific application developer based upon the specific application associated with the request. For example, the ML chatbot training data, the software development information, and/or any other suitable information may indicate who the developer(s) is/are for each application, such that when a request is received for a particular application, the application modernization server 102 is able to identify the associated developer, and use their corresponding ML chatbot 124. In one aspect, the user providing the request may be asked for a specific developer to emulate using the ML chatbot 124, e.g., via a user interface, a request from the ML chatbot 124, etc., however, the application modernization server 102 may use any suitable means to identify a specific developer to emulate using the ML chatbot 124.

The application modernization server 102 may identify the ML model 122 associated with the indicated specific application developer, and retrieve the identified ML model 122 from memory (e.g., the memory 108, the database, 110) for use as the ML chatbot 124. In one aspect, a base ML model may be trained using generic application developer training data corresponding to best practices of a generic application developer. In one example, the base model may be used as the ML chatbot 124, for example if an ML model 122 associated with a specific developer is unavailable, the specific developer is unidentified, etc. In one aspect, one or more fine-tuned ML models associated with the one or more specific application developers are accessible to the application modernization server 102, for example fine-tuned models trained and stored in memory (e.g., the memory 108, the database 110), fine-tuned models which the ML training module 116 may generate using specific application developer training datasets, etc.

In response to receiving a request, the ML chatbot 124 generates one or more responses that emulate technical knowledge of the application developer associated with the ML chatbot 124. By training and/or configuring the ML chatbot 124 to emulate technical knowledge of an application developer, a requestor may receive responses which are more technically sophisticated, informative, and/or relevant than would otherwise be received from a generalized chatbot, as the developer of the application is likely best-suited to provide application modernization information based upon developing the specific application. Accordingly, the ML chatbot 124 improves the application modernization process by providing more accurate information than would be received from conventional techniques. In one example, a generalized chatbot is not trained with developer best practices for application modernization, and may provide responses to requests related to application modernization that are counter-intuitive to best practices as a result.

In some embodiments, the ML chatbot 124 provides information associated with how a specific application developer would modernize a specific application they developed, based upon the technical knowledge of the developer. The application modernization server 102 may provide the responses the ML chatbot 124 generates to the computing device 130 associated with the requestor. For example, the server 102 may provide the response via the network 125 to the computing device 130 providing the ML chatbot interface used to submit the requests.

The computing environment 100 may include additional, fewer, and/or alternate components, and may be configured to perform additional, fewer, or alternate actions, including components/actions described herein. For example, information described as being stored at database 110 may be stored at memory 108, and therefore database 110 may be omitted. It should be appreciated that additional and/or alternative connections between components shown in FIG. 1 may be implemented. As just one example, the server 102 and the database 110 may be connected via the network 125 instead of, or in addition to, the direct communication link as shown in FIG. 1. Moreover, although the computing environment 100 depicted in FIG. 1 includes one instance of various components such as the application modernization server 102, the database 110, the network 125, and the computing device 130, various aspects include the computing environment 100 implementing any suitable number of any of the components shown in FIG. 1 and/or omitting any suitable ones of the components shown in FIG. 1. For example, the computing environment 100 may include multiple application modernization servers 102, databases 110, networks 125, and computing devices 130.

### Example ML Model Training and Operation

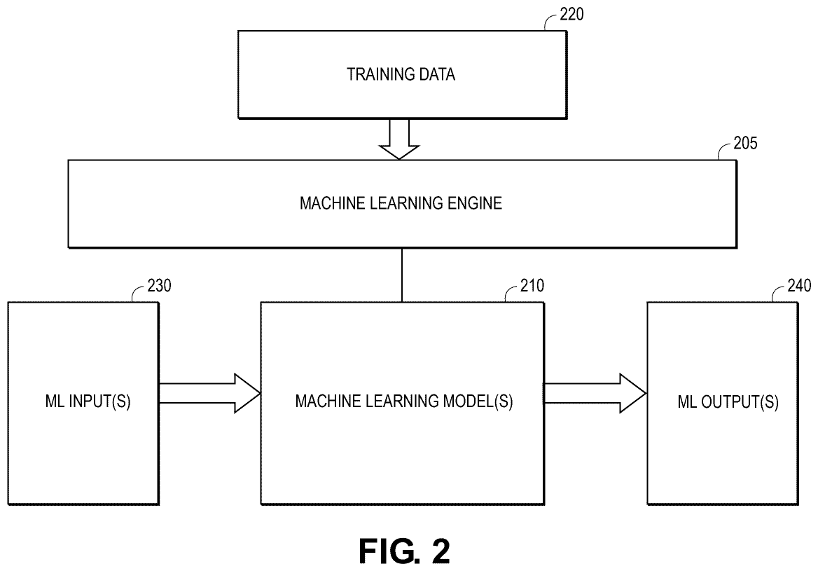

FIG. 2 depicts a data flow diagram for example training and operation of an ML model 210 for application modernization, such as the models 120, the ML model 122, and/or the ML chatbot 124, according to some aspects. Although FIG. 2 illustrates an exemplary ML model training, this does not imply that the same set of training data, inputs, and outputs shown apply to all ML models, or that any specific technique discussed herein is necessarily used for all of the ML models, as further described below.

An ML engine 205 (e.g., the ML training module 116 and/or the ML operation module 118 of the application modernization server 102) may include one or more hardware and/or software components to obtain, create, (re) train, fine-tune, and/or store the ML model 210, such as one or more of the ML models 120. To train the ML model 210, the ML engine 205 may use training data 220. A server, such as the application modernization server 102, may obtain and/or have available one or more types of training data 220 (e.g., training data stored in the database 110). In one aspect, at least some of the training data 220 may be labeled to aid in (re) training and/or fine-tuning the ML model 210. During training of the ML model 210 by the ML engine 205, the ML model 210 may be configured to process the training data 220 to learn associations and relationships in the training data 220.

In some embodiments, the ML engine 205 updates the training data 220 as needed, e.g., to include new data. Such data may be stored as updated training data 220. Subsequently, the ML model 210 may be retrained (e.g., via the ML engine 205) using the updated training data 220, or the new portions thereof, which may cause the ML model 210 to improve over time.

In some embodiments, the ML engine 205 trains the ML model 210 using the training data 220 to generate the output 240 based on the input 230. Once trained, the ML model 210 may perform operations on one or more data inputs 230 to produce a desired data output 240, such as the application modernization information and/or ML chatbot responses, as described above. In one aspect, the ML model 210 is loaded at runtime from a database (e.g., model 210 loaded by ML engine 205 from the database 110). The server and/or ML engine 205 may obtain the input data 230 (e.g., from the database 110), and the ML engine 205 may provide the input data 230 to the trained ML model 210 as an input, for the ML model 210 to generate the output 240.

In at least some aspects, the same server and/or other suitable component/device, both trains the ML model 210, and executes the trained ML model 210. In at least some aspects, a first server and/or other suitable component/device trains the ML model 210, and a second server and/or other suitable component/device executes the trained ML model 210.

### Generative Application Modernization ML Models

In one embodiment, the ML model 210 is a generative ML model. In one aspect, the generative model is the previously-described ML chatbot configured to provide one or more responses to one or more requests associated with modernizing an application. The generative model may be trained by the ML engine 205 to include generative functionality for creating new content that is in some ways similar to, or otherwise inspired by, existing examples, and/or reflective of desired features/characteristics. In one aspect, generative ML model is the ML model trained and/or configured to generate and/or rewrite code. As described above, in some of these embodiments, the ML model is and/or includes an LLM. The LLM may operate upon and only generate text (e.g., application code, text responses to modernization requests) or, in other embodiments, may be a multimodal LLM that operates upon and/or generates text and also other types of content (e.g., images such as heatmaps, audio such as audio-based responses, etc.).

In one embodiment, the application modernization server 102 receives a text prompt in the form of request associated with application modernization, and provides the text prompt as an input to the ML chatbot. In response, the ML chatbot processes the text prompt and outputs text content responsive to the request. In one aspect, the ML chatbot is trained/configured to generate and/or rewrite code of an application. In such an aspect, the application modernization server 102 receives human-readable code of the application (e.g., the software development information) as an input, provides the human-readable code as the input to the ML chatbot, and in response the ML chatbot processes the human-readable code and outputs new and/or rewritten code.

The generative ML model may include a deep neural network and may perform various natural language processing (NLP) tasks (e.g., classifying text, answering questions, summarizing text such as human-readable code, generating text such as human-readable code) as needed to understand a text query/prompt and generate a response to the text query/prompt. As one example, the prompt may be “How would you modernize application XYZ?”

The LLM may have a transformer model architecture with an encoder and decoder, and may tokenize characteristic inputs/text. The transformer model may incorporate self-attention mechanisms to facilitate faster learning/training and/or more accurate output. In some embodiments, the LLM includes many layers of neural networks, possibly including a number of embedding layers, a number of feedforward layers, and a number of recurrent layers. In alternative embodiments, the generative ML model is not an LLM. For example, the ML chatbot may instead include a less complex neural network.

The generative ML model may have been trained by application modernization server 102 or another computing system using unsupervised or semi-supervised learning, for example, and with training data of the appropriate modality (text) or modalities (e.g., text as well as images and/or audio). The ML chatbot may be a general-purpose model (e.g., trained on a wide array of publicly available datasets such as web pages, documents, etc., available via the Internet) or may be a domain-specific model (e.g., trained on custom and/or proprietary datasets, such as generic application developer training data corresponding to best practices of a generic application developer, specific application developer training data representing technical knowledge of a specific application developer, or other domain-specific information associated with application modernization).

In some embodiments, the ML model is and/or includes the LLM with parameters tuned, via the training process, specifically for high performance in generating and/or rewriting code for application modernization. In example, to ML model may be modernize two applications which have redundant technical requirements, each has some of the same functionality, and each has some unique functionality. The ML model may both rewrite the code of the first application, and generate new code for the first application, so that that the modernized first application retains its technical requirements and previous functionality, and also includes the functionality of the second application, so that the second application may be retired.

In some embodiments, the ML chatbot is an/or includes LLM with parameters tuned, via the training process, specifically for high performance in providing an output using the technical knowledge of generic application developers, or specific application developers. In one example, the ML chatbot may be trained to answer requests associated with application modernization using a base ML model having the technical knowledge of a generic application developer and associated best practices of the generic application developer. In one example, the ML chatbot may be trained to answer requests associated with application modernization of a specific application using a fine-tuned ML model based upon the base ML model, the fine-tuned ML model having the technical knowledge of a specific application developer of the specific application developer, as well as the technical knowledge of the generic application developer.

### Non-Generative Application Modernization ML Model

In one embodiment, the ML model 210 is an ML model trained by the ML engine 205 using training data 220 including application modernization training data. In such an embodiment, the application modernization training data corresponds to best practices for modernizing historical applications based upon historical software development information. The training may use supervised training techniques (e.g., with manually added labels associated with application modernization, technical requirements, and the like for historical software development information associated with historical applications), and/or unsupervised learning techniques, depending on the type of the ML model 210. As an unsupervised example, the ML model 210 may include an LLM trained to interpret the human-readable code of the software development information. In at least one aspect, the LLM may be a publicly available LLM, which is fine-tuned using training data associated with human-readable code (e.g., syntax of various coding languages).

Once trained, the ML model 210 may be trained to receive software development information as an input 230 and generate as an output 240 application modernization information corresponding to at least one application, and may not include the ability to generate/rewrite code, and may not include the ML chatbot. The application modernization information may include one or more technical requirements of a corresponding application. For example, the application modernization server 102 may receive software development information comprising human-readable code, develop comments and application commit information for 25 applications. The application modernization server 102, via the ML engine 205, may provide the software development information as an input 230 to the ML model 210. The ML model 210 may generate, as an output 240, application modernization information that indicates the technical requirements of each of the 25 applications, identifies 4 applications which share at least some of the same technical requirements with recommendation to generate new code for 1 of the 4 applications and rewrite code for the other 3 applications, identifies 5 applications which are best suited to be modernized by being hosted in a cloud environment, identifies 1 application which should be retired due to minimal use/value to the application provider and end-user, and 15 applications which do not require modernization.

While various ML models 210 are described with respect to FIG. 2 and more generally throughout the disclosure, a single ML model may provide at least some functionality associated with one or more separately described ML models. For example, the ML model may be trained to generate application modernization information, and be the ML chatbot. Conversely, the functionality described with respect to a single ML model may be implemented by one or more separate ML models. Moreover, one or more ML models may be trained to have additional functionality that may not be expressly described. Furthermore, although each of the ML models is described as generating specific output(s) based upon specific input(s), the ML models may receive other input(s) and/or produce other output(s) not expressly described.

### Example System for Application Modernization

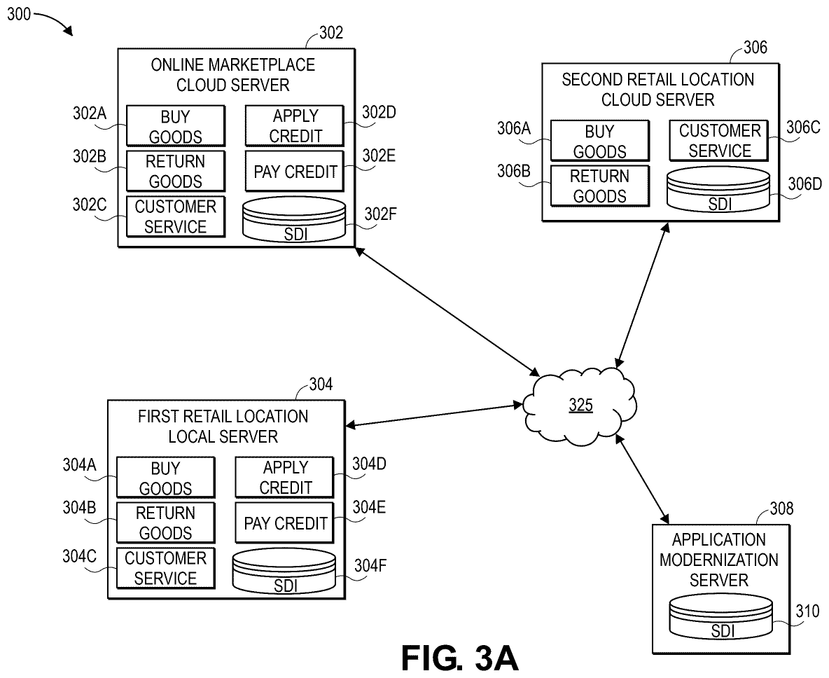

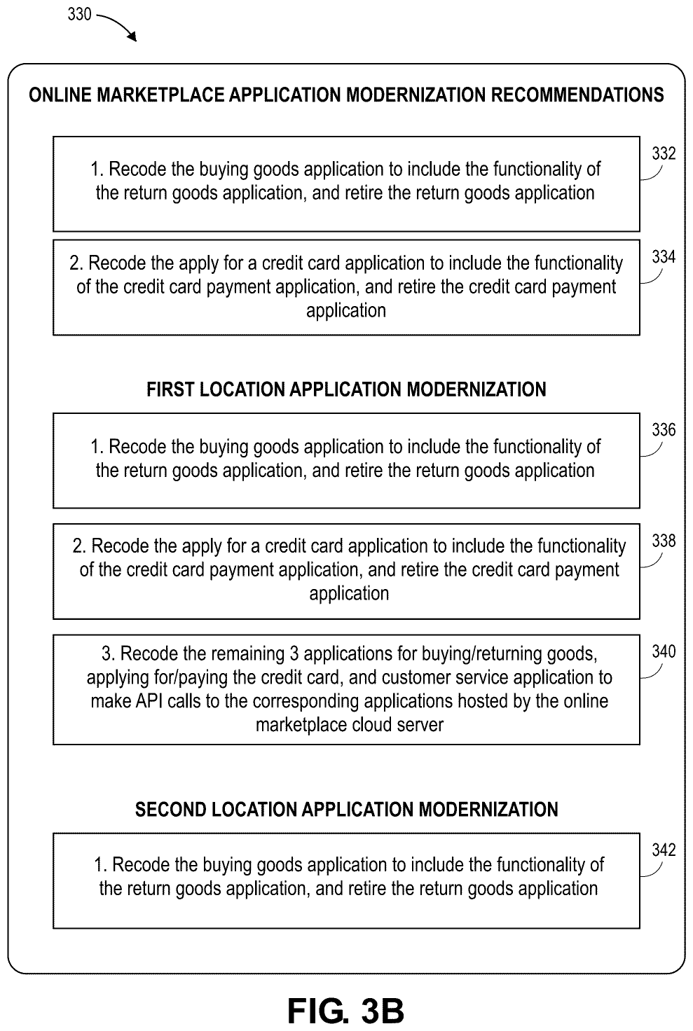

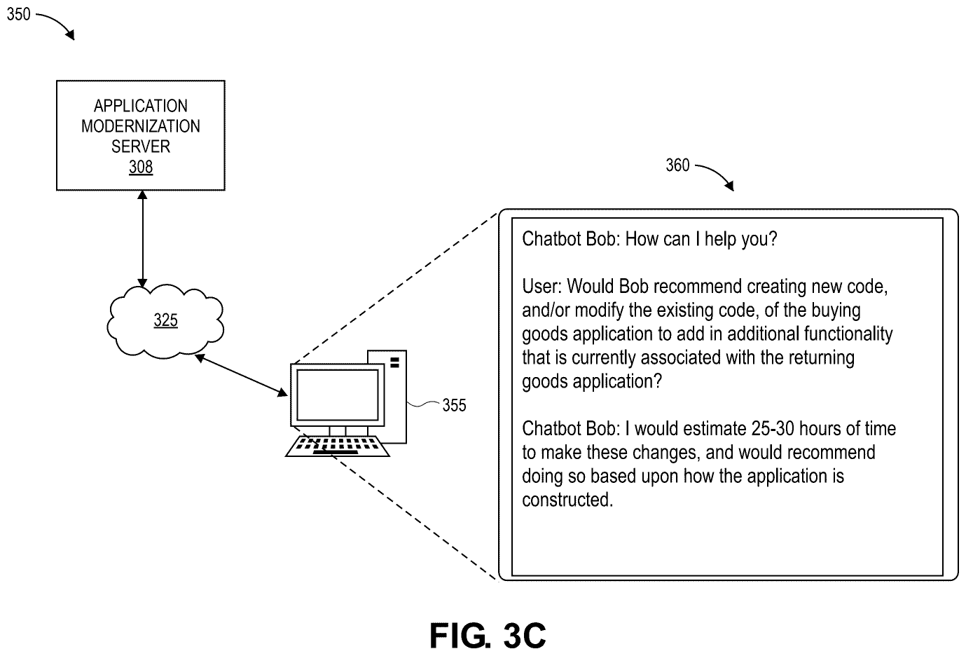

FIG. 3A depicts a block diagram of example application modernization system 300, according to some aspects. The application modernization system 300 may assess a portfolio of applications for modernization. According to an example illustrated by FIG. 3A, Retailer X supports an application portfolio including 13 applications being used by its online marketplace and two brick-and-mortar retail locations. The online marketplace supports five applications hosted by a cloud server 302, the five applications associated with (i) buying goods 302A, (ii) returning goods 302B, (iii) customer service 302C, (iv) applying for a Retailer X credit card 302D, and (v) Retailer X credit card payment 302E, respectively. The First Retail Location supports five applications 304A-304E having the same functionality as the five online marketplace applications, except the First Retail Location applications are separately developed from the online marketplace applications, and hosted on local (non-cloud) server 304 at the First Retail Location. The Second Retail Location does not offer lines of credit, and therefore supports three separately developed applications for (i) buying goods 306A, (ii) returning goods 306B, and (iii) customer service 306C, which are hosted by a cloud server 306.

The Retailer X provides the application modernization server 308, of an application modernization service provider, access to an online marketplace database 302F, a First Retail Location database 304F, and a Second Retail Location database 306D. The databases 302F, 304F, 306D store the software development information associated with the online marketplace applications 302A-E, the First Retail Location applications 304A-E, and the Second Retail Location applications 306A-C, respectively. The application modernization server 308, such as the application modernization server 102, accesses the databases 302F, 304F, 306D over a network 325, such as network 125, to retrieve the collective software development information. The application modernization server 308 retrieves an ML model, such as the ML models 122, 210, from a local database 310. The application modernization server 308 loads the ML model for execution (e.g., via the ML operation module 118), and provides the collective software development information to the ML model. The ML model analyzes the software development information, including human-readable code associated with the applications 302A-E, 304A-E, 306A-C included in the collective software development information, to generate application modernization information corresponding to the applications 302A-E, 304A-E, 306A-C. The application modernization information includes the technical requirements corresponding to the functionality of the applications 302A-E, 304A-E, 306A-C, which the ML model extracts from the software development information. The application modernization information also includes one or more application modernization recommendations based upon the technical requirements. The application modernization server 308 provides the application modernization information to a computing device, such as computing device 130, associated with the Retailer X. The application modernization information is then displayed for viewing by individuals associated with Retailer X, as described in reference to FIG. 3B.

Namely, FIG. 3B depicts an example computing device user interface 330 displaying the application modernization information associated with modernizing the applications of Retailer X. The application modernization information includes multiple modernization recommendations, but it should be appreciated that the modernization recommendations may include more/fewer and/or different recommendations than illustrated in FIG. 3B.

As an example, for the online marketplace, a first recommendation 332 includes recoding (i.e., generate new code and/or rewrite existing code) the buying goods application 302A to include the functionality of the return goods application 302B, and retiring the return goods application 302B. A second recommendation 334 includes recoding the apply for a credit card application 302D to include the functionality of the credit card payment application 304E, and retiring the credit card payment application 302E. Accordingly, the online marketplace application modernization recommendations 332, 334 include reducing five applications to three applications via application recoding and retirement, while retaining the functionality of all five applications.

As another example, for the First Retail Location, a first recommendation 336 includes recoding the buying goods application 304A to include the functionality of return goods application 304B, and retiring the return goods application 304B. A second recommendation 338 includes recoding the apply for a credit card application 304D to include the functionality of the credit card payment application 304E, and retiring the credit payment application 304E. A third recommendation 340 includes recoding the remaining three applications for buying/returning goods, applying for/paying the credit card, and customer service, to make application programming interface (API) calls to the corresponding applications hosted by the online marketplace cloud server 302, thereby allowing the online marketplace cloud server 302 to host some of the functionality of the First Retail Location applications. Rehosting application functionality via API calls can increase the speed of the execution of the First Retail Location applications. Accordingly, the First Retail Location application modernization recommendations 336, 338, 340 include reducing five applications to three applications via application recoding and retirement, while retaining the functionality of all five applications, and rehosting some functionality of the applications in the cloud.

As yet another example, for the Second Retail Location, the recommendation 342 includes recoding the buying goods application 306A to include the functionality of return goods application 306B, and retiring the return goods application 306B. Accordingly, the Second Retail Location application modernization recommendation 342 includes reducing three applications to two applications via application recoding and retirement, while retaining the functionality of all three applications.

Andy, an employee at the Retailer X, is uncertain whether to accept the recommendation 338 associated with the opening credit/paying credit applications for the First Retail Location. Although the existing First Retail Location applications 304D, 304E of the recommendation have worse performance characteristics than the corresponding online marketplace applications 302D, 302E, Andy is not knowledgeable enough in application development to understand if the changes indicated by the recommendation 338 would resolve or improve these technical issues. Andy would like to consult with Bob, the application developer of the First Retail Location applications, for advice regarding how feasible the recommended application modernizations would be. Unfortunately, Bob is no longer employed by the Retailer X. However, the software development information generated by Bob for the First Retail Location applications is stored in a database, including human-readable source code, associated metadata, change logs, commit information, etc., of the First Retail Location applications. To avoid completely losing Bob's technical knowledge, the application modernization service provider may accordingly train an ML chatbot (e.g., the ML chatbot 124) with Bob's software development information. This then allows the ML chatbot to operate with Bob's technical knowledge respective to the First Retail Location applications and, once trained, Andy can ask the ML chatbot the questions he would have otherwise asked Bob and receive answers that emulate what Bob may have provided in response.

The application modernization service provider already has a trained base ML chatbot model trained with the technical knowledge of best practices of a generic application developer. The Retailer X provides the application modernization server 308 access to the database 304F storing Bob's application developer information indicating Bob's technical knowledge, and comprising a developer training dataset the application modernization server 308 will use to fine-tune the ML chatbot. The application modernization server 308 retrieves Bob's application developer training dataset from the database 304F via the network 325. The application modernization server ML training module, such as the ML training module 116, fine-tunes the base ML chatbot model using Bob's application developer information as the developer training dataset, to generate a fine-tuned ML chatbot model having the Bob's technical knowledge respective to the First Retail Location applications. The application modernization server 308 stores Bob's fine-tuned ML chatbot model in a memory, such as the models 120 of the memory 108, in the database 310, etc. The application modernization server 308 generates a hyperlink to an online chatbot interface which is configured to provide requests to Bob's fine-tuned ML chatbot, and transmits the hyperlink to Andy's computing device 355, via the network 325.

FIG. 3C depicts a block diagram of an example ML chatbot system 350 for application modernization, according to an aspect. Andy uses his computing device 355, such as computing device 130, to access the online chatbot interface 360 associated with Bob's fine-tuned ML chatbot. In response to Andy's computing device 355 accessing the online chatbot interface 360, the application modernization server 308 retrieves Bob's fine-tuned ML chatbot model from the database 310, and loads it as the ML chatbot of the online chatbot interface 360. Andy would like to determine how feasible it would be to modernize the First Retail Location applications, as indicated in the second recommendation 338 of the application modernization information.

As illustrated in FIG. 3C, Andy submits a request to Bob's fine-tuned ML chatbot via the online chatbot interface 360, asking, “Would Bob recommend creating new code, and/or modify the existing code, of the buying goods application to add in additional functionality that is currently associated with the returning goods application?” The online chatbot interface 360 generates data comprising Bob's request, and provides the data to Bob's fine-tuned ML chatbot. The ML chatbot generates a response, which the application modernization server 308 displays on the online chatbot interface 360, Bob's fine-tuned chatbot response indicating, “I would estimate 25-30 hours of time to make these changes, and would recommend doing so based upon how the application is constructed.” Andy is able to view the response on his computing device 355, and make a decision about the First Retail Location application modernization based on the response emulating Bob's technical knowledge of the First Retail Location applications, even though Bob is no longer with Retailer X and/or available for direct consultation.

### Example Method

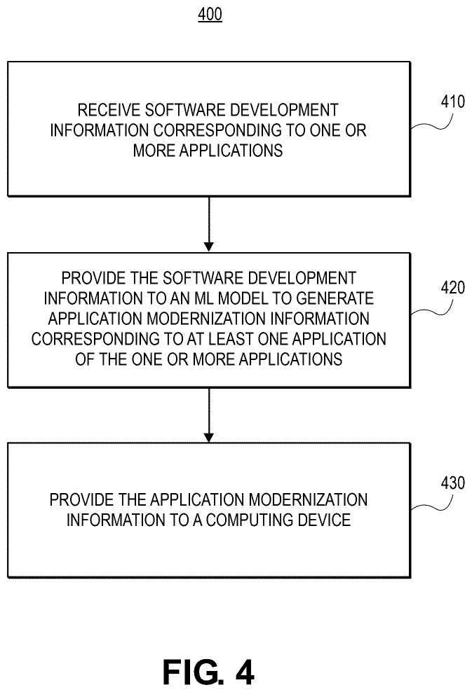

FIG. 4 depicts a flow chart of an example computer-implemented method 400 for application modernization using machine learning (ML), in accordance with various embodiments herein. Generally speaking, the actions described herein in reference to FIG. 4 may be performed, in part or in whole, by the computing environment 100, and/or any other suitable components described herein or combinations thereof. Further, it should be appreciated that any of the actions of the exemplary method 400 described herein may be performed any suitable number of times, in any suitable order, and/or may be optional in certain embodiments.

The computer-implemented method 400 may include receiving, by one or more processors (e.g. processor 104), software development information corresponding to one or more applications (block 410). The software development information may include human-readable code.

The computer-implemented method 400 may include providing, by the one or more processors, the software development information to an ML model (e.g., ML models 122, 210) to generate application modernization information (block 420). The ML model may be trained using application modernization training data corresponding to best practices for modernizing historical applications based upon historical software development information. The ML model may include an LLM trained to interpret the human-readable code. The application modernization information may include one or more technical requirements of a corresponding application. The one or more technical requirements may include at least one of: (i) application functionality, (ii) application rules, (iii) user experiences, (iv) application security, (v) application deployment, or (vi) application performance. The application modernization information may include one or more application modernization recommendations of the corresponding application based upon the one or more technical requirements of the corresponding application.

In one aspect of the computer-implemented method 400, the application modernization information includes one or more heatmaps indicating application cloud readiness and/or application modernization complexity diagrams. In one aspect of the computer-implemented method 400, the application modernization information may include an application modernization recommendation including one or more of: (i) deduplicating applications having redundant technical requirements, (ii) generating new source code for an application, (iii) rewriting existing source code of the application, (iv) retiring the application, (v) retaining the application, (vi) replatforming the application, (vii) repurchasing the application, or (viii) rehosting the application. In one aspect of the computer-implemented method 400, the application modernization information indicates more than one application having a same technical requirement.

In one aspect of the computer-implemented method 400, the ML model may be further trained to generate the new source code, and/or rewrite the existing source code. In such an aspect, the computer-implemented method 400 may further include generating, via the ML model, at least a portion of the new source code; and/or rewriting, via the ML model, at least a portion of the existing source code.

The computer-implemented method 400 may include providing, by the one or more processors, the application modernization information to a computing device (block 430).

In one aspect of computer-implemented method 400, the ML model includes an ML chatbot. In such an aspect, generating the application modernization information may further include: receiving, by the one or more processors from the computing device, a request associated with modernizing an application of the one or more applications; providing, by the one or more processors, the request to the ML chatbot, wherein the ML chatbot is trained at least to generate responses that emulate technical knowledge of an application developer of the application; generating, by the ML chatbot, a response to the request; and providing, by the one or more processors, the response to the computing device.

In one aspect, the computer-implemented method 400 may include: (i) training, by the one or more processors, a base ML model using generic application developer training data corresponding to best practices of a generic application developer; (ii) fine-tuning, by the one or more processors, the base ML model (a) using one or more specific application developer training datasets corresponding to one or more specific application developers of the one or more applications, each specific application developer training dataset representing technical knowledge of a specific application developer for a corresponding application, and (b) to generate one or more fine-tuned ML models associated with the one or more specific application developers; and (iii) storing, by the one or more processors, the one or more fine-tuned ML models on one or more memories, wherein the ML chatbot is one such fine-tuned ML model. In such an aspect, each specific application developer training dataset may indicate source code changes of the specific application developer for the corresponding application.

In one aspect, the computer-implemented method 400 may include: (i) obtaining, by the one or more processors, an indication of a specific application developer, of the one or more specific application developers; (ii) identifying, by the one or more processors, the fine-tuned ML model associated with the indicated specific application developer; and (iii) retrieving, by the one or more processors, the identified fine-tuned ML model from the one or more memories, for use as the ML chatbot. In such an aspect, the indication may be based upon the application developer of the application indicated by the request.

### ADDITIONAL CONSIDERATIONS

The following considerations also apply to the foregoing discussion. Throughout this specification, plural instances may implement operations or structures described as a single instance. Although individual operations of one or more methods are illustrated and described as separate operations, one or more of the individual operations may be performed concurrently, and nothing requires that the operations be performed in the order illustrated. These and other variations, modifications, additions, and improvements fall within the scope of the subject matter herein.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of “a” or “an” is employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for implementing the concepts disclosed herein, through the principles disclosed herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

Although the following text sets forth a detailed description of numerous different embodiments, it should be understood that the legal scope of the description is defined by the words of the claims set forth at the end of this text. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term” “is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. § 112(f).

What is claimed:

1. A system for application modernization using machine learning (ML), the system comprising:
one or more memories having stored thereon computer-executable instructions that, when executed by one or more processors, cause the system to:
receive software development information corresponding to one or more applications, the software development information including human-readable code;
provide the software development information to an ML model, wherein the ML model:
(i) is trained using application modernization training data corresponding to best practices for modernizing historical applications based upon historical software development information,
(ii) includes a large language model (LLM) trained to interpret the human-readable code, and
(iii) generates application modernization information corresponding to at least one application of the one or more applications, the application modernization information including (a) one or more technical requirements of a corresponding application and (b) one or more application modernization recommendations of the corresponding application based upon the one or more technical requirements; and
responsive to generating the application modernization information, provide the application modernization information to a computing device.

2. The system of claim 1, wherein the application modernization information includes a heatmap indicating one or more of application cloud readiness or application modernization complexity diagrams.

3. The system of claim 1, wherein the one or more technical requirements include at least one of: (i) application functionality, (ii) application rules, (iii) user experiences, (iv) application security, (v) application deployment, or (vi) application performance.

4. The system of claim 3, wherein the application modernization information indicates more than one application having a same technical requirement.

5. The system of claim 1, wherein the one or more application modernization recommendations include at least one of: (i) deduplicating applications having redundant technical requirements, (ii) generating new source code for an application, (iii) rewriting existing source code of the application, (iv) retiring the application, (v) retaining the application, (vi) replatforming the application, (vii) repurchasing the application, or (viii) rehosting the application.

6. The system of claim 5 wherein:
the ML model is further trained to generate the new source code, and/or rewrite the existing source code; and
the system further comprises instructions that, when executed by the one or more processors, cause the system to:
generate, via the ML model, at least a portion of the new source code; and/or
rewrite, via the ML model, at least a portion of the existing source code.

7. The system of claim 1, wherein;
the ML model includes an ML chatbot; and
to generate the application modernization information, the system further comprises instructions that, when executed by the one or more processors, cause the system to:
receive, from the computing device, a request associated with modernizing an application of the one or more applications;
provide the request to the ML chatbot, wherein the ML chatbot is trained at least to generate responses that emulate technical knowledge of an application developer of the application;
generate, by the ML chatbot, a response to the request; and
provide the response to the computing device.

8. The system of claim 7, further comprising instructions that, when executed by the one or more processors, cause the system to:
train a base ML model using generic application developer training data corresponding to best practices of a generic application developer;
fine-tune the base ML model
using one or more specific application developer training datasets corresponding to one or more specific application developers of the one or more applications, each specific application developer training dataset representing technical knowledge of a specific application developer for a corresponding application, and
to generate one or more fine-tuned ML models associated with the one or more specific application developers; and
store the one or more fine-tuned ML models on the one or more memories, wherein the ML chatbot is one such fine-tuned ML model.

9. The system of claim 8, wherein each specific application developer training dataset indicates source code changes of the specific application developer for the corresponding application.

10. The system of claim 8, further comprising instructions that, when executed by the one or more processors, cause the system to:
obtain an indication of a specific application developer, of the one or more specific application developers;
identify the fine-tuned ML model associated with the indicated specific application developer; and
retrieve the identified fine-tuned ML model from the one or more memories, for use as the ML chatbot.

11. The system of claim 10, wherein the indication is based upon the application developer of the application indicated by the request.

12. A system for application modernization using a machine learning (ML) chatbot, the system comprising:
one or more memories having stored thereon computer-executable instructions that, when executed by one or more processors, cause the system to:
receive, from a user via a computing device, a request associated with modernizing an application;
provide the request to the ML chatbot, wherein the ML chatbot is trained at least to generate responses that emulate technical knowledge of an application developer of the application;
in response to providing the request to the ML chatbot, generate, by the ML chatbot, a response to the request; and
provide the response to the computing device.

13. A computer-implemented method for application modernization using machine learning (ML), the computer-implemented method comprising:
receiving, by one or more processors, software development information corresponding to one or more applications, the software development information including human-readable code;
providing, by the one or more processors, the software development information to an ML model, wherein the ML model:
(i) is trained using application modernization training data corresponding to best practices for modernizing historical applications based upon historical software development information,
(ii) includes a large language model (LLM) trained to interpret the human-readable code, and
(iii) generates application modernization information corresponding to at least one application of the one or more applications, the application modernization information including (a) one or more technical requirements of a corresponding application and (b) one or more application modernization recommendations of the corresponding application based upon the one or more technical requirements; and
providing, by the one or more processors, the application modernization information to a computing device.

14. The computer-implemented method of claim 13, wherein the one or more technical requirements include at least one of: (i) application functionality, (ii) application rules, (iii) user experiences, (iv) application security, (v) application deployment, or (vi) application performance.

15. The computer-implemented method of claim 13, wherein the one or more application modernization recommendations include at least one of: (i) deduplicating applications having redundant technical requirements, (ii) generating new source code for an application, (iii) rewriting existing source code of the application, (iv) retiring the application, (v) retaining the application, (vi) replatforming the application, (vii) repurchasing the application, or (viii) rehosting the application.

16. The computer-implemented method of claim 15 wherein:
the ML model is further trained to generate the new source code, and/or rewrite the existing source code; and
the computer-implemented method further comprises:
generating, via the ML model, at least a portion of the new source code; and/or
rewriting, via the ML model, at least a portion of the existing source code.

17. The computer-implemented method of claim 13, wherein:
the ML model includes an ML chatbot; and
generating the application modernization information further comprises:
receiving, by the one or more processors from the computing device, a request associated with modernizing an application of the one or more applications;
providing, by the one or more processors, the request to the ML chatbot, wherein the ML chatbot is trained at least to generate responses that emulate technical knowledge of an application developer of the application;
generating, by the ML chatbot, a response to the request; and
providing, by the one or more processors, the response to the computing device.

18. The computer-implemented method of claim 17, further comprising:
training, by the one or more processors, a base ML model using generic application developer training data corresponding to best practices of a generic application developer;
fine-tuning, by the one or more processors, the base ML model
using one or more specific application developer training datasets corresponding to one or more specific application developers of the one or more applications, each specific application developer training dataset representing technical knowledge of a specific application developer for a corresponding application, and
to generate one or more fine-tuned ML models associated with the one or more specific application developers; and
storing, by the one or more processors, the one or more fine-tuned ML models on one or more memories, wherein the ML chatbot is one such fine-tuned ML model.

19. The computer-implemented method of claim 18, further comprising:
obtaining, by the one or more processors, an indication of a specific application developer, of the one or more specific application developers;
identifying, by the one or more processors, the fine-tuned ML model associated with the indicated specific application developer; and
retrieving, by the one or more processors, the identified fine-tuned ML model from the one or more memories, for use as the ML chatbot.

20. The computer-implemented method of claim 19, wherein the indication is based upon the application developer of the application indicated by the request.
